(19) United States
(12) Patent Application Publication
(10) Pub. No.: US 2008/0210307 A1
(43) Pub. Date: Sep. 4, 2008

(54) CONTROL OF SLIT VALVE DOOR SEAL PRESSURE

(76) Inventors: Takayuki Matsumoto, San Jose, CA (US); Shinichi Kurita, San Jose, CA (US)

Correspondence Address: PATTERSON & SHERIDAN, LLP - - APPM/TX, 3040 POST OAK BOULEVARD, SUITE 1500, HOUSTON, TX, 77056, US

(21) Appl. No.: 12/039,508

(22) Filed: Feb. 28, 2008

Related U.S. Application Data
(60) Provisional application No. 60/892,511, filed on Mar. 1, 2007.

(51) Int. Cl. F16K 25/00; F16K 31/12; F17D 1/00

(52) U.S. Cl. 137/14; 251/167; 251/12

(57) ABSTRACT

Apparatuses and methods are provided for sealing a slit valve passage between two substrate processing chambers. A body with two openings to register with openings in the walls of the process chambers, and a passageway between them, houses a sealing member configured to extend and retract to block or open the passageway. The sealing member comprises a seal on one face that covers one opening, and a moveable lateral extension on the other face that braces against the other opening. The extension is actuated to contact the wall of the body, providing a bracing or sealing force to the seal on the other face of the sealing member. The sealing force may be adjusted by varying the gas pressure to the sealing member based on pressure conditions in the process chambers.

### CROSS-REFERENCE TO RELATED APPLICATIONS

This application claims benefit of U.S. provisional patent application Ser. No. 60/892,511 (APPM/11888L), filed Mar. 1, 2007, which is herein incorporated by reference.

### BACKGROUND OF THE INVENTION

1. Field of the Invention

Embodiments of the present invention generally relate to a silt valve for interfacing between two vacuum chambers.

2. Description of the Related Art

In semiconductor, flat panel display, photovoltaic/solar panel, and other substrate processing systems, it is common to arrange vacuum chambers (i.e., load locks, transfer chambers, process chambers) in a cluster, in-line, or a combination of cluster/in-line arrangements to process substrates. These systems may process substrates in a single or batch substrate fashion. During processing, substrates may be transferred to and from chambers in which vacuum must be maintained or established. To allow access to the inside of the chamber, and to enable vacuum operation, an opening in the shape of a slit is frequently provided to accommodate the substrate being processed. The opening is usually sealed by a door that retracts to open the slit and moves into position covering the slit to seal the chamber.

At each interface between two vacuum chambers, a slit valve assembly may be present. A slit valve door may be movably actuated to open or close the slit valve passageway. The slit valve passageway, when open, permits one or more substrates to be transferred between the two vacuum chambers through the slit valve. When the slit valve passageway is closed by a slit valve door, substrates may not be transferred between the two vacuum chambers through the slit valve passageway and the two vacuum chambers are isolated from each other. For example, one of the vacuum chambers may be a process chamber which requires isolation from other chambers, which may be other process chambers or a transfer chamber.

As the substrate size for manufacturing flat panel display grows, the manufacturing equipment for these substrates becomes larger in size as well. Accordingly, the door or gate that isolates one vacuum chamber (or load lock chamber) from another becomes larger or, specifically, longer because the slot opening between the two chambers has to become longer to accommodate the large width of the substrate passing through the slot opening. The increasing length of the door poses technical challenges for obtaining a good isolation seal between the two chambers, which is maintained by an elastomeric seal disposed around the slot opening between the door and a chamber wall.

Therefore, there is a need for a slit valve door capable of sealing chambers used to process large area substrates.

### SUMMARY OF THE INVENTION

Embodiments described herein provide a slit valve assembly, comprising a slit valve body comprising a first wall and a second wall; and a slit valve door disposed within the slit valve body, the slit valve door comprising a sealing surface facing the first wall; a bracing surface substantially parallel to the sealing surface facing the second wall, wherein the bracing surface may extend away from the sealing surface; and a gas supply configured to vary a sealing force on the sealing surface.

Other embodiments provide an apparatus for coupling two vacuum chambers together, comprising a sealing member comprising a first face and a second face; a seal coupled to the first face; a moveable extension coupled to the second face; one or more lift rods coupled to the sealing member, each lift rod comprising a conduit in communication with the moveable extension; and a gas supply of adjustable pressure in communication with one or more of the conduits.

Other embodiments provide a method, comprising disposing a slit valve door between a first chamber and a second chamber, the slit valve door having a sealing surface and a bracing surface substantially parallel to the sealing surface; supplying a gas between the sealing surface and the bracing surface to close the slit valve door; and adjusting a distance between the sealing surface and the bracing surface to control sealing force.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A-1C are schematic cross-sectional views of a slit valve assembly according to one embodiment of the invention.

FIG. 2 is a schematic control diagram according to one embodiment of the invention.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

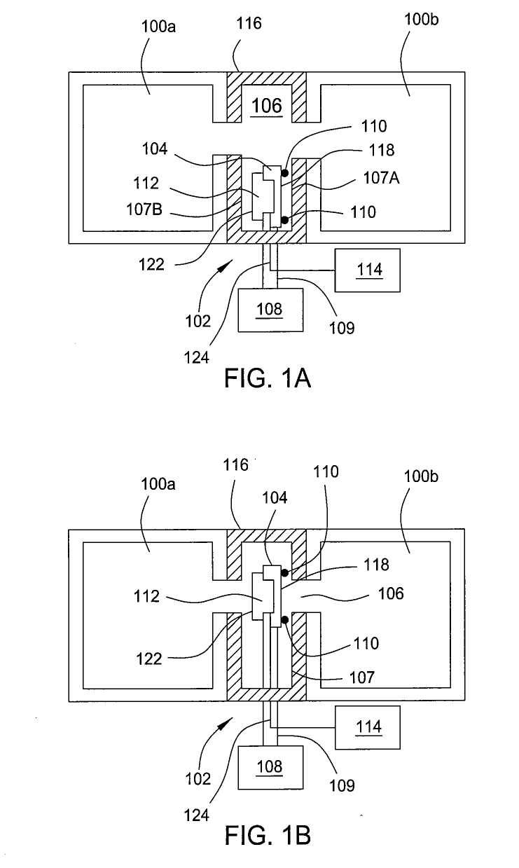

For ease of Illustration, embodiments of the present invention will be described in reference to FIGS. 1A-1C with the vacuum chamber 100a comprising a transfer chamber and the vacuum chamber 100b comprising a process chamber. Exemplary transfer chambers and process chambers are available from AKT™, a subsidiary of Applied Materials, Inc., located in Santa Clara, Calif. Slit valve assemblies are also disclosed in U.S. Pat. No. 7,086,638 assigned to Applied Materials, Inc., and are all incorporated by reference to the extent they are not inconsistent with this disclosure. It is contemplated that the invention is equally applicable between any two vacuum chambers, including those produced by other manufacturers.

FIGS. 1A-1C are schematic cross-sectional views of one embodiment of two vacuum chambers 100a and 100b coupled together by a slit valve assembly 102. The slit valve assembly 102 includes a slit valve body 116 that defines a slit valve passageway 106, and a sealing member 104 for sealing the slit valve passageway 106. The slit valve body 116 has a first wall 107A and a second wall 107B, embodying two internal surfaces of the slit valve body 116. A lift mechanism 108, such as a pneumatic, belt-driven, screw-driven, or other suitable mechanism, is coupled to the sealing member 104 by one or more lift rods 109 to raise the sealing member 104 to block the slit valve passageway 106 or to lower the sealing member 104 to leave the slit valve passageway 106 open.

The sealing member 104, which may be a slit valve door, further includes a first face 118, which may be a sealing surface, facing the internal surface embodied by the first wall 107A and a second face 120 substantially parallel to the first face 118 facing the internal surface embodied by the second wall 107B. The sealing member 104 may further include a moveable extension 112, which may be a bracing member, coupled to the second face 120. The extension 112 has a bracing surface 122 substantially parallel to the first face 118 and the second face 120, and facing the second wall 107B, that is configured to extend away from the first face 118 when extension 112 is operated. As the bracing surface 122 extends away from the first face 118, it comes into contact with the second wall 107B. As the bracing surface 122 is extended further, it pushes the first face 118 to contact the first wall 107A.

A seal 110, which may be an o-ring, sealing pad, or gasket, seals the slit valve passageway 106 when the first face 118 contacts the first wall 107A. In this embodiment, the extension 112 expands laterally to provide a sealing force between the seal 110 and the first wall 107A, and retracts to create space between the first face 118 and the first wall 107A, and the bracing surface 122 and the second wall 107B, thus allowing vertical movement of the sealing member 104 by the lift mechanism 108.

The bracing surface 122 and the first face 118 cooperatively define an internal cavity (not shown) inside the sealing member 104. An external actuator 114 is coupled to the moveable extension 112 to laterally expand or laterally retract the extension 112, thus moving the bracing surface 122 with respect to the first face 118. In one embodiment, the external actuator 114 is a pneumatic actuator which applies pressure to the internal cavity inside the sealing member 104 to expand the moveable extension 112 and releases the pressure to retract the extension 112. A fluid, such as a gas, is provided to the internal cavity through one or more conduits 124 that are provided through one or more of the lift rods 109 and are in communication with the internal cavity and the external actuator 114. In an alternate embodiment, the external actuator 114 may be hydraulically operated, providing a liquid to the internal cavity through the conduits 124.

In FIG. 1A, the sealing member 104 is moveably disposed in a lowered position to leave the slit valve passageway 106 open. In FIG. 1B, the sealing member 104 is moveably disposed in a raised position in which the extension 112 is retracted. In FIG. 1C, the extension 112 of the sealing member 104 is expanded to provide a sealing force between the seal 110 and the first wall 107A of the slit valve passageway 106.

In certain instances, different sealing force levels will be applied to the sealing surface by supplying gas at varying pressures to the sealing member. The need for different sealing force levels may arise from changing process conditions in the chambers to be sealed. A sealing force level that is too low may cause leakage of gas or air from the environment (i.e., if the chamber is opened up to air for maintenance) through the slit valve passageway. A sealing force level that is too high may damage the slit valve assembly. For example, if the sealing force level is too high there may be metal-to-metal contact between slit valve assembly components causing undesirable particle formation.

Typically, in normal operation, both process chambers will be at vacuum for processing of substrates. In this instance, a “low” sealing force/pressure is applied to the lateral member. From time-to-time, one process chamber may need to be vented to atmosphere for maintenance thereof while the other chamber remains at vacuum. For example, a transfer chamber may be in operation to transfer substrates to other chambers, while a process chamber coupled to the transfer chamber via a slit valve assembly is at atmospheric pressure. In this instance, a “high” sealing force/pressure is applied to the lateral member to help prevent the leaks from the high pressure chamber to the low pressure chamber. From time-to-time, the transfer chamber may need to be vented to atmosphere for maintenance thereof while the process chamber remains at vacuum. In this instance, a “low” sealing force/pressure is applied to the lateral member because the pressure of the transfer chamber adds to the sealing force of the lateral member (i.e., the atmospheric pressure of the transfer chamber presses against the lateral member helping to urge the seal against the slit valve passageway wall).

In one embodiment, the pressure applied to extend the lateral member is set at a high pressure setting, such as about 35 psi or above, whenever the process chamber is at atmosphere pressure. The pressure setting to extend the lateral member is set at a low pressure setting, such as about 25 psi or below, whenever the process chamber is at vacuum pressure (such as 300 torr or below). The pressure settings are summarized in the below Table 1.

TABLE 1

| | Transfer | Process | |
|---|---|---|---|
| | Chamber | Chamber | Pressure Applied to the Lateral |
| | Condition | Condition | Member |
| Case 1 | Vacuum | Vacuum | Low |
| Case 2 | Vacuum | Atmosphere | High |
| Case 3 | Atmosphere | Vacuum | Low |
| Case 4 | Atmosphere | Atmosphere | High |

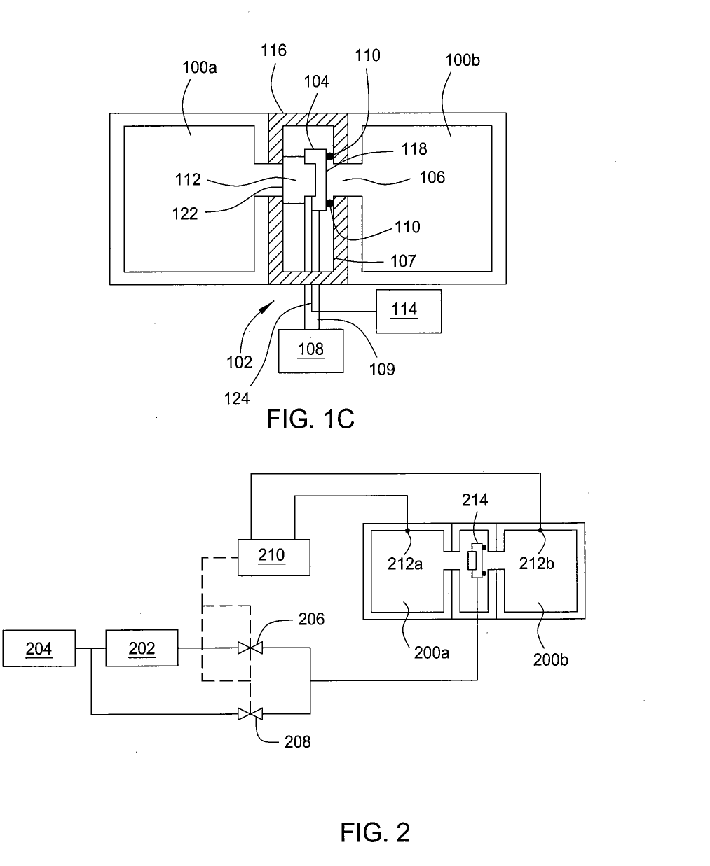

In certain embodiments, the process chamber pressure condition may be monitored and pressure applied to the sealing member may be automatically adjusted. FIG. 2 is a schematic control diagram illustrating a control system for automatically adjusting the pressure applied to a bracing member of a slit valve door such as that described above based upon the process chamber pressure. Gas is supplied from gas source 204, which may comprise one or more gas canisters, to actuate a bracing member of sealing member 214. A pressure regulator 202 is provided to reduce the supply pressure of the gas going to the sealing member 214 to enable application of low sealing force. Valves 206 and 208 may be operated to apply low or high sealing force. Valve 208 may be closed and valve 206 opened to apply low sealing force, and vice-versa to apply high sealing force. Pressure sensors 212a and 212b may be used to sense pressure in chambers 200a and 200b, respectively. A selector 210, which may be a control device, may operate valves 206 and 208 in response to pressures in the respective chambers. When chamber 200a is at high pressure and chamber 200b at low pressure, selector 210 may close valve 206 and open valve 208 to apply high sealing force to the bracing member. When chamber pressures call for low sealing force, as delineated in the table above, selector 210 may open valve 206 and close valve 208 to apply low sealing force to the bracing member. Applied to the scenario described above, atmospheric pressure in the process chamber will open valve 208 and close valve 206 to apply a high pressure to the bracing member. Vacuum in the process chamber opens valve 206 and closes valve 208 and a low pressure is provided to the bracing member. In an alternate embodiment, valves 206 and 208 may be replaced by a 3-way valve switchable between two sources. [0024] Providing a low pressure to the bracing member when the transfer chamber is at atmospheric pressure and the process chamber under vacuum reduces metal-to-metal contact in the slit valve assembly. Providing a high pressure to the bracing member when the transfer chamber is under vacuum and the process chamber is at atmospheric pressure provides an improved sealing force between the seal and the slit valve passageway wall and reduces leakage therethrough. Thus, using a plurality of gas sources at different pressures, embodied alternately as a gas at ambient pressure selectably controlled by a pressure regulator or as multiple gas supplies at different pressures, and a selector for applying one source at a time to the conduit in the bracing member, enables the slit valve assembly to maintain an operable seal as process conditions change.

In operation, embodiments of the present invention provide a method of sealing openings at one end of a passageway, such as a slit valve passageway, between two vacuum chambers. A sealing member such as the sealing member 104 of FIGS. 1A-1C, having a seal on one face and a lateral member projecting from the other face, is disposed in a slit valve passageway between a first chamber and a second chamber by a lifting mechanism. The lateral member may be configured as described in the above embodiment, depicted in FIGS. 1A-1C. The sealing member, having a sealing surface and a bracing surface substantially parallel to the sealing surface, is positioned such that the sealing surface covers a first opening in a wall of the first chamber at one end of the passageway, while the lateral member having the bracing surface covers a second opening in a wall of the second chamber at the other end of the passageway, while the seal covers an opening at the other end of the passageway. The lateral member is extended to adjust the distance between the sealing surface and the bracing surface, such that the bracing surface contacts the wall area surrounding the second opening and transmits a bracing or sealing force to the seal disposed in the sealing surface. The seal impinges the wall area surrounding the first opening of the passageway, thus sealing the slit valve passageway at both ends. The lateral member may be extended using pressurized gas applied through a conduit in the sealing member to the inside of the sealing member to force the lateral member outward. When an open passageway is desired, the lateral member may be retracted and the sealing member lowered.

While the foregoing is directed to embodiments of the present invention, other and further embodiments of the invention may be devised without departing from the basic scope thereof, and the scope thereof is determined by the claims that follow.

What is claimed is:

1. A slit valve assembly, comprising:
a slit valve body comprising a first wall and a second wall; and
a slit valve door disposed within the slit valve body, the slit valve door comprising:
a sealing surface facing the first wall;
a bracing surface substantially parallel to the sealing surface facing the second wall, wherein the bracing surface is configured to extend away from the sealing surface; and
a gas supply configured to vary a sealing force on the sealing surface.

2. The apparatus of claim 1, further comprising a conduit inside the slit valve door in communication with the internal cavity and the gas supply.

3. The apparatus of claim 1, wherein the bracing surface contacts the second wall when it is extended.

4. The apparatus of claim 3, wherein the sealing surface contacts the first wall when the bracing surface is extended.

5. The apparatus of claim 1, further comprising a lift mechanism coupled to the slit valve door.

6. The apparatus of claim 5, wherein the lift mechanism is pneumatically actuated.

7. The apparatus of claim 2, wherein the gas supply comprises one or more gas sources and one or more valves for applying a selected gas source to the conduit.

8. An apparatus for coupling two vacuum chambers together, comprising:
a sealing member comprising a first face and a second face;
a seal coupled to the first face;
a moveable extension coupled to the second face;
one or more lift rods coupled to the sealing member, each lift rod comprising a conduit in communication with the moveable extension; and
a gas supply of adjustable pressure in communication with one or more of the conduits.

9. The apparatus of claim 8, wherein the gas supply comprises a plurality of gas sources at different pressures.

10. The apparatus of claim 8, wherein the seal comprises an o-ring.

11. The apparatus of claim 8, further comprising a housing with a first surface facing the first face and a second surface facing the second face.

12. The apparatus of claim 11, wherein the moveable extension contacts the second surface when it is extended.

13. The apparatus of claim 8, wherein the sealing member further comprises an internal cavity and one or more openings in registration with the one or more conduits.

14. The apparatus of claim 8, further comprising a selector for selecting a gas pressure to apply to each conduit.

15. A method, comprising:
disposing a slit valve door between a first chamber and a second chamber, the slit valve door having a sealing surface and a bracing surface substantially parallel to the sealing surface;
supplying a gas of adjustable pressure between the sealing surface and the bracing surface to close the slit valve door; and
adjusting a distance between the sealing surface and the bracing surface to control sealing force.

16. The method of claim 15, wherein applying a gas of adjustable pressure between the sealing surface and the bracing surface comprises routing pressurized gas through a conduit in the slit valve door.

17. The method of claim 16, further comprising sensing the difference in pressure between the first chamber and the second chamber and adjusting the pressure of the pressurized gas based on the difference in pressure between the first chamber and the second chamber.

18. The method of claim 16, wherein supplying the pressurized gas comprises providing a plurality of gas sources at different pressures and a selector for applying one source at a time to the conduit.

19. The method of claim 15, further comprising blocking a passage between the first chamber and the second chamber by sealing a first opening in a wall of the first chamber with the sealing surface and applying a sealing force to the bracing surface.

20. The method of claim 19, further comprising opening the passage between the first chamber and the second chamber by lowering the slit valve door.
